(19) United States
(12) Patent Application Publication
(10) Pub. No.: US 2016/0047161 A1
(43) Pub. Date: Feb. 18, 2016

(54) FIREPROOF DOORFRAME HAVING WATER CURTAIN AND CONSTRUCTION METHOD THEREFOR

(71) Applicants: Dong-sub PARK, (US); Gwang-hyun SHIN, (US)

(72) Inventors: Dong-sub PARK, Gyeonggi-do (KR); Gwang-hyun SHIN, Seoul (KR)

(21) Appl. No.: 14/780,541

(22) PCT Filed: Mar. 28, 2014
(86) PCT No.: PCT/KR2014/002695

§ 371 Date: Sep. 27, 2015

(30) Foreign Application Priority Data
Mar. 28, 2013 (KR) 10-2013-0033540
Mar. 24, 2014 (KR) 10-2014-0033895

(51) Int. Cl. E06B 5/16; E06B 1/52; E04B 1/94

(52) U.S. Cl. CPC E06B 5/16; E04B 1/941; E06B 1/52

(57) ABSTRACT

The present invention provides a fireproof doorframe having a water curtain for a shelter space, which is capable of saving lives by being installed in a bathroom provided with water so as to prevent flames and poisonous gases from entering the bathroom in the case of a fire, comprising: a first end cover having a side cover part covering the end of the side of a provisional doorframe and an upper side cover part covering the upper side of the provisional doorframe; a door accommodating part formed to protrude upwards from the upper side cover part; a door supporting part formed to be stepped upward from the side of the door accommodating part; a second end cover formed to be near the door supporting part and having a side cover part covering the end of the opposite side of the provisional doorframe and an upper side cover part covering the upper side of the opposite side of the doorframe; and a first water tank accommodated in the doorframe accommodating part and including a nozzle part formed toward the doorframe, wherein a first water tank accommodating part is formed inside the door supporting part and is open upward such that the first water tank can be provided therein, and a through-hole for accommodating the nozzle part is formed at the lower surface of the first water tank accommodating part.

### TECHNICAL FIELD

The present invention relates to a fireproof doorframe having a water curtain and a construction method therefor, and more particularly, to a fireproof doorframe having a water curtain capable of saving human lives such as disabled persons or the old and the infirm by providing a fireproof doorframe having a water curtain in a space such as a household bathroom where there is water and there is no combustible material during the construction of all buildings such as houses and providing an air supply device and a water sprinkling device that prevent flames and poisonous gases from being introduced to the inside in case of fire.

### BACKGROUND ART

In recent years, many high-rise apartments and multipurpose building have been constructed.

However, when fire occurs in a high-rise apartment and a high-rise building, there is a problem that an aerial ladder of a fire engine cannot approach the high-rise apartment and high-rise building in order to suppress fire.

In order to prevent such a problem, the high-rise building is recently regulated such that an evacuation zone is separately provided in case of fire.

However, since such a regulation is not applied to high-rise apartments and buildings constructed before such a regulation is established, there is a problem that an evacuation zone is not provided even in the high-rise building.

Even in the building provided with the evacuation zone according to the regulation, since most interior construction materials are made of combustible materials and are easily combusted and enveloped in flames, there is a difficulty that residents escape from the room and cannot move to the evacuation zone.

In order to solve such a problem, Korean Utility Model Registration No. 20-0331768 discloses a wooden fireproof door made in which a nonflammable sheet is inserted between plywoods.

In the case of the fireproof door, fire resistance to flames is improved, but there is still a problem about sealing properties against poisonous gases.

### DISCLOSURE OF INVENTION

### Technical Problem

In order to solve the problems described above, an object of the present invention is to provide a fireproof doorframe having a water curtain which has sealing properties and is capable of easily being provided, defending flames and preventing poisonous gases from being introduced to the inside in case of fire.

### Technical Solution

In order to achieve the above object, the present invention provides a fireproof doorframe having a water curtain that is provided so as to cover a provisional doorframe. The fireproof doorframe includes: a first end cover part that includes a side cover part which covers a side end of the provisional doorframe, and an upper side cover part which covers an upper side of the provisional doorframe; a door accommodating part that is formed so as to protrude upwards from the upper side cover part; a door supporting part that is formed so as to be stepped upwards from a side of the door accommodating part; a second end cover part that includes a side cover part which is formed adjacent to the door supporting part to cover a facing side end of the provisional doorframe, and an upper side cover part which covers a facing side upper side of the provisional doorframe; and a first water tank that is accommodated in the door accommodating part, and is provided with nozzle parts formed in a direction facing the door. A first water tank accommodating part that is formed within the door supporting part so as to be opened upwards, and is capable of providing the first water tank, and a through hole for accommodating the nozzle parts is formed in a lower surface of the first water tank accommodating part.

In order to achieve the above object, the present invention provides a fireproof doorframe having a water curtain that is provided so as to cover a provisional doorframe. The fireproof doorframe includes: a first cover that is fixed so as to cover one end of the provisional doorframe; a second cover that is fixed so as to cover the facing other end of the provisional doorframe; and a first water tank that is accommodated in the second cover, and is provided with nozzle parts formed in a direction facing a door. The first cover includes a first end cover part that includes a side cover part which covers a side of the one end of the provisional doorframe, and an upper side cover part which covers an upper side of the one end of the provisional doorframe, the second cover includes a door accommodating part formed so as to protrude upwards from the upper side cover part, a door supporting part formed so as to be stepped upwards from a side of the door accommodating part, and a second end cover part which is formed adjacent to the door supporting part, and includes a side cover part which covers a facing side end of the provisional doorframe and an upper side cover part which covers a facing side upper side of the provisional doorframe, a first water tank accommodating part that is formed so as to be opened upwards and is capable of providing the first water tank is provided within the door supporting part, and a through hole for accommodating the nozzle parts is formed in a lower surface of the first water tank accommodating part.

In order to achieve the above object, the present invention provides a fireproof doorframe having a water curtain that is provided so as to cover a provisional doorframe. The fireproof doorframe includes: a first end cover that is fixed so as to cover one end of the provisional doorframe; a central cover that is fixed so as to cover the first cover; a second end cover that is disposed adjacent to the central cover, and is fixed so as to cover the facing other end of the provisional doorframe; and a first water tank that is accommodated in the central cover, and is provided with nozzle parts formed in a direction facing a door. The first end cover includes a first end cover part that includes a side cover part which covers a side of the one end of the provisional doorframe, and an upper side cover part which covers an upper side of the one end of the provisional doorframe, the central cover includes a door accommodating part formed so as to protrude upwards from the upper side cover part, and a door supporting part formed so as to be stepped upwards from a side of the door accommodating part, the second end cover includes a side cover part that covers the facing other end of the provisional doorframe, and an upper side cover part that covers an upper side of the one end of the provisional doorframe, a first water tank accommodating part that is formed so as to be opened upwards and is capable of providing the first water tank is formed within the door supporting part, and a through hole for accommodating the nozzle parts is formed in a lower surface of the first water tank accommodating part.

In the fireproof doorframe having a water curtain of the present invention, the end cover part, the door accommodating part, and the door supporting part may be integrally formed.

In the fireproof doorframe having a water curtain of the present invention, a first groove may be formed in an upper end of the door supporting part in order to accommodate the upper side cover part extending in a horizontal direction of the first end cover part.

In the fireproof doorframe having a water curtain of the present invention, a first groove may be formed in an upper end of the door supporting part in order to accommodate the upper side cover part extending in a horizontal direction of the first end cover part, and a second groove may be formed in an upper end of the door accommodating part in order to accommodate the upper side cover part extending in a horizontal direction of the second end cover part.

In the fireproof doorframe having a water curtain of the present invention, an insertion groove for accommodating a gasket may be formed in a stepped end of the door supporting part adjacent to the door accommodating part.

In the fireproof doorframe having a water curtain of the present invention, a water line for supplying water from the outside may be connected to the first water tank.

In the fireproof doorframe having a water curtain of the present invention, a valve that is controlled so as to be manually or automatically opened and closed may be provided at the water line.

In the fireproof doorframe having a water curtain of the present invention, a groove may be formed in the provisional doorframe in an inward direction of the first end cover part, and a second water tank accommodating part that is accommodated in the groove and is formed as an internal closing space may be formed at the first end cover part.

The fireproof doorframe having a water curtain of the present invention may include a door accommodating part that is formed at one end so as to accommodate a door; and a door supporting part that is formed so as to be stepped upwards with respect to the door accommodating part. A first water tank accommodating part formed as a closing space may be formed within the door supporting part, and a first nozzle hole may be formed in a lower surface of the first water tank accommodating part in a direction facing a door.

In the method of constructing fireproof doorframe having a water curtain of the present invention, the fireproof doorframe having a water curtain may be constructed on any one end of the upper end and the side end of the door of the fireproof doorframe having a water curtain, or both ends thereof.

In the method of constructing fireproof doorframe having a water curtain of the present invention, the first water tank of the fireproof doorframe having a water curtain which is provided at the upper end and the first water tank of the fireproof doorframe having a water curtain which is provided at the side end may be integrally formed.

In the method of constructing fireproof doorframe having a water curtain of the present invention, the fireproof doorframe having a water curtain may be constructed such that an extension line of a central line of the nozzle part of the fireproof doorframe having a water curtain which is constructed at a side end of the door crosses an extension line of a central line of the nozzle part of the fireproof doorframe having a water curtain which is constructed at a top of the door.

In a fireproof doorframe system having a water curtain, an air supply device may be additionally provided in a space where the fireproof doorframe having a water curtain is provided, the air supply device may include an air supply fan that introduces external air to supply the introduced air into the space, and an emergency power source that drives the air supply fan, and the air supply fan may be controlled so as to be simultaneously operated when the valve is opened.

### Effect of the Invention

The fireproof doorframe having a water curtain of the present invention is constructed in all buildings such as apartments by using a bathroom where there is water as an evacuation zone. Since the fireproof doorframe having a water curtain can be constructed using an existing doorframe in supervision services of an existing house or building, it is possible to reduce the damage of human lives, and it is possible to save costs and times.

In the fireproof doorframe having a water curtain of the present invention, water is injected to a surface of a door from a doorframe in case of fire, and the injected water forms a water curtain on the surface of the door while flowing down the door. Accordingly, the door is not combusted, and thus, it is possible to prevent flames and poisonous gases from being generated due to the combustion of the door.

The water injected to the door is introduced into a gap between the door and the doorframe and forms a water curtain, and thus, it is possible to prevent the poisonous generated from the outside from being introduced into the inside using an air supply device and a water sprinkling device.

Water injecting openings are provided at both upper ends of the door in addition to the top of the doorframe, and thus, it is possible to increase the fire resistance of the door by injecting water in corners of the upper end of the door.

Since a gasket is attached to the fireproof doorframe having a water curtain, it is possible to absorb impact sound of the door in a normal situation, and it is possible to prevent poisonous gases from being introduced by forming a sealing state in case of fire.

Meanwhile, a second water tank is provided on the inside of the door in addition to the outside of the door when necessary and is configured as a structure capable of injecting water, and thus, it is possible to further improve fireproof performance by forming the water curtains on the inside and the outside of the door.

### DESCRIPTION OF DRAWINGS

FIG. 1 is a diagram showing a sectional view of a fireproof doorframe having a water curtain of the present invention.

FIG. 2 is a diagram showing a connected state of the fireproof doorframe having a water curtain of the present invention with a water line.

FIG. 3 is a diagram showing an operation state of the fireproof doorframe having a water curtain of the present invention.

FIG. 4 is a diagram showing another embodiment of the fireproof doorframe having a water curtain of the present invention.

FIG. 5 is a diagram showing still another embodiment of the fireproof doorframe having a water curtain of the present invention.

FIG. 6 is a diagram showing a fireproof doorframe system having a water curtain of the present invention.

FIG. 7 is a diagram showing a second embodiment of the fireproof doorframe having a water curtain of the present invention.

FIG. 8 is a diagram showing another case of the second embodiment of the fireproof doorframe having a water curtain of the present invention.

FIG. 9 is a diagram showing a third embodiment of the fireproof doorframe having a water curtain of the present invention.

FIG. 10 is a diagram showing a fourth embodiment of the fireproof doorframe having a water curtain of the present invention.

### BEST MODE

Hereinafter, embodiments of the present invention will be described with reference to the drawings.

### First Embodiment

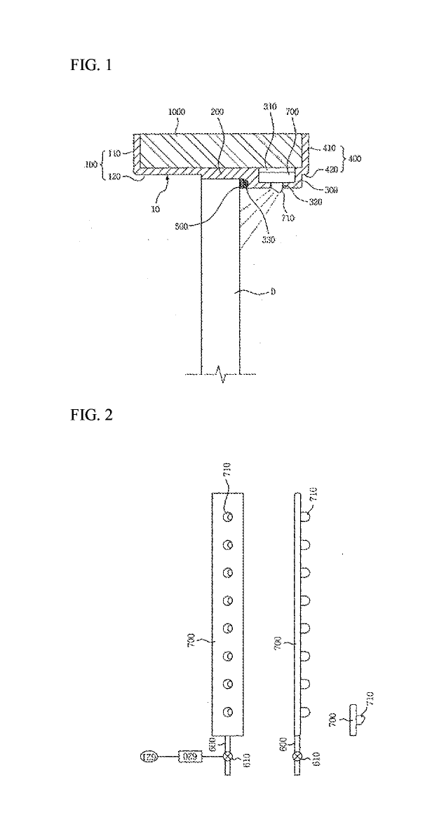

FIG. 1 is a diagram showing a sectional view of a fireproof doorframe having a water curtain of the present invention.

A fireproof doorframe 10 having a water curtain may be made of a wooden material or a synthetic resin, and in the first embodiment, a first end cover 100, a door accommodating part 200, a door supporting part 300, and a second end cover part 400 are integrally provided.

The first end cover part 100 includes a side cover part 110 that covers an end of a side of a provisional doorframe F, and an upper side cover part 120 that covers an upper side of a provisional doorframe 1000, and is formed at one end of the provisional doorframe.

The door accommodating part 200 formed so as to protrude upwards is formed inside the upper side cover part 120.

The door accommodating part 200 serves to support and accommodate a side end part or an upper end part of a door D.

The door supporting part 300 is formed on a side of the door accommodating part 200 so as to be stepped upwards.

A first water tank accommodating part 310 is formed inside the door supporting part 300 so as to be open upwards.

A first through hole 320 for accommodating first nozzle parts 710 is formed in a lower surface of the first water tank accommodating part 310.

A groove 330 into which a gasket 500 is inserted is formed on a stepped side of the door supporting part 300 adjacent to the door accommodating part 200.

The second end cover part 400 is formed so as to be adjacent to the door supporting part 300, and includes a side cover part 410 that covers a side end of the provisional doorframe F, and an upper side cover part 420 that covers an upper side of the provisional doorframe 1000.

FIG. 2 is a diagram showing a first water tank in the fireproof doorframe having a water curtain of the present invention.

The first water tank 700 is made of a metal material such as stainless steel having corrosion resistance, and is formed in a shape capable of being accommodated in the first water tank accommodating part 310.

The first nozzle parts 710 are formed at a lower end of the first water tank 700 is provided with so as to be inclined toward the door.

The first water tank 700 is attached within the first water tank accommodating part 310, the first nozzle parts 710 of the first water tank 700 are inserted into the first through hole 320 formed in the door supporting part 300, and in this case, the first nozzle parts 710 are provided in a direction facing the door.

As shown in FIG. 2, a water line 600 is connected to a side portion or an upper portion of the first water tank 700, and a valve 610 is provided at the water line 600.

The valve 610 is manually operated or is automatically operated through a fire monitoring sensor (not shown) within a building.

The fireproof doorframe having a water curtain of the present invention is preferably provided at an entrance door of a bathroom, and in so doing, it is possible to easily ensure the water line unlike another internal space.

Since the bathroom has ventilation facilities, it is easy to relatively discharge a poisonous gas, and since there is water, it is easy to make provisions against fire.

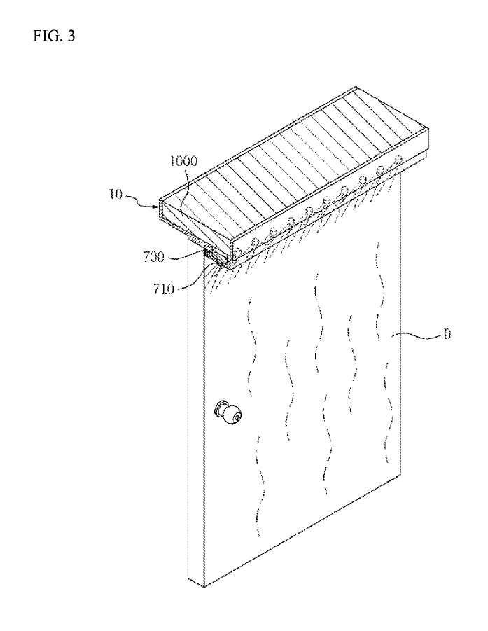

Next, the operation of the fireproof doorframe having a water curtain will be described. FIG. 3 is a diagram showing an operation state of the fireproof doorframe having a water curtain of the present invention.

In case of fire, the valve 610 is manually operated, or is automatically opened by a fire detecting sensor (not shown) provided at a building.

When the valve 610 is opened, water is introduced into the first water tank 700 through the water line, and the water is injected toward the door through the plurality of first nozzle parts 700.

Since the water injected from the first nozzle parts 710 is injected to a surface of the door, the water forms a water curtain on the entire door while flowing down the door.

Accordingly, it is possible to prevent the door from being burned due to the water curtain formed on the door.

The water injected onto the door is introduced into a gap between the door and the fireproof doorframe 10 having a water curtain while flowing down the door, and the introduced water serves to seal the gap therebetween. Accordingly, it is possible to prevent the poisonous gas from being introduced to the inside.

In the fireproof doorframe 10 having a water curtain of the present invention, since the gasket 500 is formed, the gasket has an operation of buffering the impact of the door in a normal situation, and an operation of doubly prevent the poisonous gas from being introduced to the inside through the gap in cooperation with the water curtain introduced into the gap in case of fire.

Particularly, the fireproof doorframe 10 having a water curtain of the present invention can be provided without disassembling the existing door, the fireproof doorframe can be easily provided, can be economical, and does not need high costs and efforts.

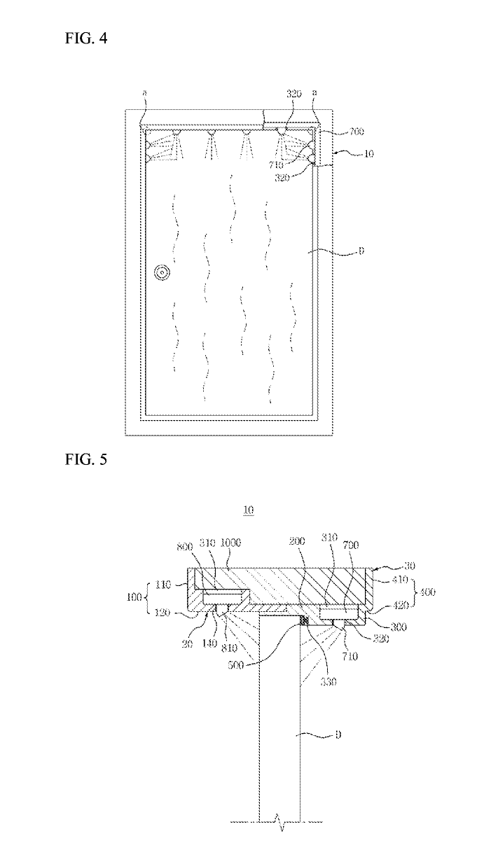

FIG. 4 is a diagram showing an operation state of another embodiment of the fireproof doorframe having a water curtain of the present invention.

In another embodiment of the present invention, the fireproof doorframe having a water curtain may be additionally provided at the side end of the door in addition to the upper end of the door.

When the fireproof doorframe having a water curtain is also provided at the side end of the door, the first water tank 700 is formed in a rightward U shape of which a vertical portion and a horizontal portion are integrally formed.

When the fireproof doorframe having a water curtain is provided at only the upper end of the door, since the water injected from the first nozzle parts 710 adjacent to each other on both sides is sloshed due to the collision of water at the center of the upper end of the door, the water curtain is formed on the surface of the door, and thus, there is not a big problem in view of fire resistance.

However, since the first nozzle parts 710 are present at only the center of the door and the first nozzle parts 710 are not present at the ends of the door, the water is not sufficiently injected to both corners a of the upper end of the door, and thus, there may be a problem in view of fire resistance.

When the fireproof doorframe 10 having a water curtain is also provided at the side end of the door, since the water injected to the side end of the fireproof doorframe 10 having a water curtain and the water injected to the upper end of the fireproof doorframe 10 having a water curtain collide with each other, the water is supplied to the corners a of the upper end of the door, and the water curtain is formed. Accordingly, the fireproof doorframe can have fire resistance.

As shown in FIG. 4, the fireproof doorframe is preferably constructed such that an extension line of the central line of the first nozzle parts 710 of the fireproof doorframe having a water curtain, which is constructed at the side end of the door, crosses an extension line of the central line of the first nozzle parts 710 of the fireproof doorframe having a water curtain, which is constructed at the top of the door.

With such a configuration, the water injected from the nozzle holes of the fireproof doorframe having a water curtain at the upper end of the door and the water injected form the nozzle holes of the fireproof doorframe having a water curtain at the side end of the door more actively collide with each other, and thus, it is possible to more certainly exhibit a cooling effect on the corners a of the upper end of the door.

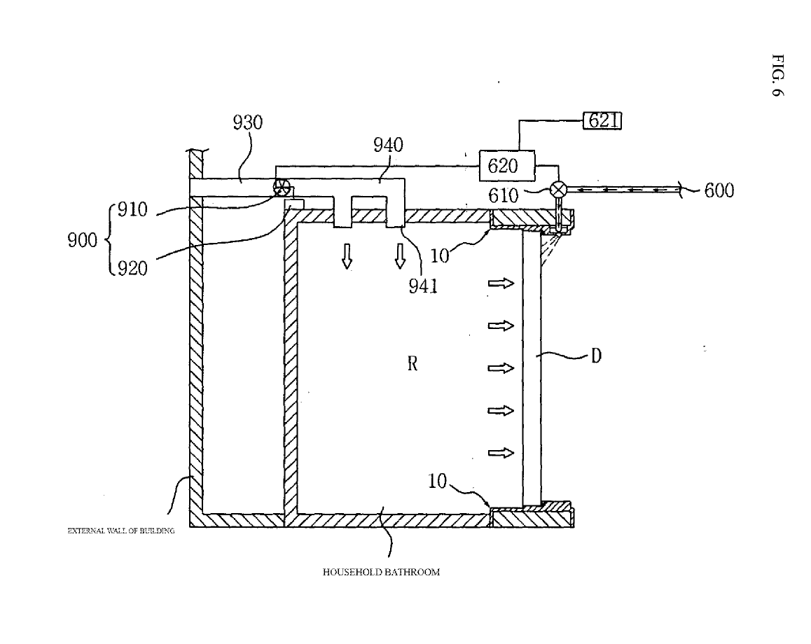

FIG. 5 is a diagram showing still another embodiment of the fireproof doorframe having a water curtain of the present invention.

In still another embodiment of the present invention, a water curtain may be formed on the inside of the door in addition to the outside of the door.

A groove 1010 is formed in the facing end of the door supporting part 300 inside the provisional doorframe 1000, and the first end cover part 100 that covers the groove 1010 may be accommodated in the groove 1010, and the second water tank accommodating part 130 that is formed as an inner closing space is formed.

A second nozzle hole 140 is formed so as to penetrate a lower surface of the second water tank accommodating part 130 in a direction facing the door.

The second water tank 800 is accommodated in the second water tank accommodating part 130, and second water nozzle parts 710 are formed in a lower end of the second water tank 800 so as to be inclined toward the door, similarly to the first water tank 700.

The second nozzle parts 710 are inserted into the second through hole 140 formed in the door supporting part 300, and in this case, the second nozzle parts 810 are formed in a direction facing the door.

Water is supplied to the second water tank 800 through the water line 600. In case of fire, the first water tank 700 serves to form a water curtain on the outside of the door, and the second water tank 800 serves to form the water curtain on the inside of the door. Accordingly, the water curtains are formed on the inside and the outside of the door, and thus, it is possible to doubly achieve the fire resistance and the operation of sealing the poisonous gas.

FIG. 6 is a diagram showing a system in which the fireproof doorframe having a water curtain of the present invention is provided.

The fireproof doorframe having a water curtain of the present invention may be provided in a household bathroom and a space R, and in this case, an air supply device 900 for inducing external air into the space R may be additionally provided.

The air supply device 900 includes an air supply fan 910 that introduces the external air to supply the introduced air into the space R, and an emergency power source 920 that supplies power for rotating the air supply fan 910.

The air supply fan 910 is provided in the household bathroom. When the household is exposed to the outside, the air supply fan 910 may be provided at the window of the household bathroom so as to directly introduce the external air to the space R.

Alternatively, when the household bathroom is not exposed to the outside, the air supply fan 910 is provided in the household bathroom as shown in FIG. 6, but may be introduce the external air into the space R through a separate suction duct 930 between an external wall of the building in which the household bathroom is provided and the air supply fan 910.

The emergency power source 920 for driving the air supply fan 910 is operated when normal power supply is stopped due to natural disaster such as fire or earthquake.

An air blowing duct 940 provided with a plurality of outlets 941 is additionally provided in an air blowing part of the air supply fan 910, and the external air is blown into the space R in various directions.

The operation of the present embodiment will be described. When a control unit 620 is manually operated or the valve 610 is opened by the fire detecting sensor 621 in case of fire, the control unit 620 simultaneously operates the air supply fan 910.

The internal pressure of the space R is increased by introducing the external air into the space R by the operation of the air supply fan 910, and it is possible to prevent the poisonous gas to be introduced to the inside from the outside of the space R from being introduced in case of fire.

Particularly, in the present embodiment, it is possible to prevent the poisonous gas from the outside from being introduced through the gap between the door and the doorframe.

### Description of the Preferred Embodiments

### Second Embodiment

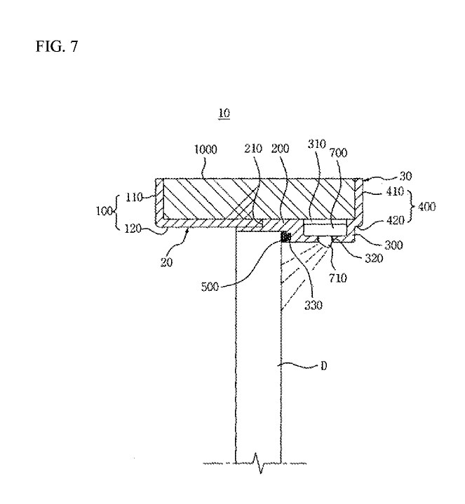

FIG. 7 is a diagram showing a second embodiment of the fireproof doorframe having a water curtain of the present invention.

Unlike the first embodiment in which the door and the fireproof doorframe are integrally formed, in the second embodiment of the present invention, the fireproof doorframe having a water curtain includes two covers.

That is, a fireproof doorframe 10 having a water curtain of the second embodiment includes a first cover 20 that is fixed so as to cover one end of a first end provisional doorframe, and a second cover 30 that is fixed to cover the facing other end of the provisional doorframe.

The first cover 20 has the same configuration as the first end cover part 100 of the first embodiment, but the second embodiment is different from the first embodiment in that the top side cover part 120 is formed so as to be longer in a horizontal direction.

In the second cover 30, the door accommodating part 200, the door supporting part 300 and the second end cover part 400 of the first embodiment are integrally formed.

However, the second embodiment is different from the first embedment in that a first groove 210 is formed at the upper end of the door supporting part 200 close to the first cover 20 in order to accommodate the upper side cover part 120 of the first cover 20 extending in the horizontal direction.

The other configurations of the door supporting part 300 and the second end cover part 400 are the same as those of the first embodiment.

Similarly to the first embodiment, the water line 600 is connected to the end of the first water tank 700, and the valve 610 is provided at the water line 600.

It is possible to exhibit the same effects of preventing the door from being burned and preventing the poisonous gas from being introduced due to water sprinkling as those in the first embodiment.

As effects different from those of the first embodiment, when a width of the provisional doorframe is different in the first embodiment, there is inconvenience that the fireproof doorframe having a water curtain is separately manufactured depending on a width, whereas since the fireproof doorframe includes two covers in the second embodiment, the fireproof doorframe can be provided by adjusting the distance between the widths of the provisional doorframes provided using the same product even when the widths of the provisional doorframes are different from each other. Accordingly, the second embodiment has a different from the first embodiment in that fireproof doorframes having a water curtain having separate width dimensions are provided.

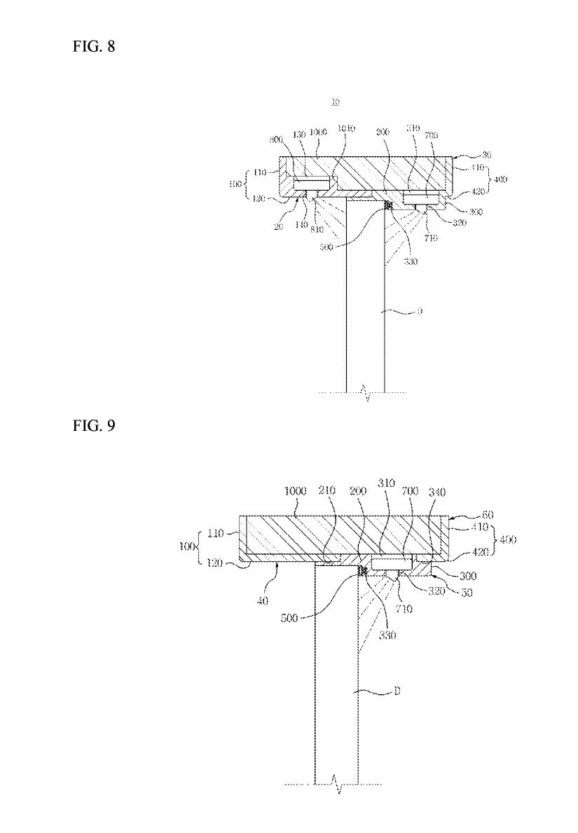

FIG. 8 is a diagram showing another case of the second embodiment of the fireproof doorframe having a water curtain of the present invention.

FIG. 8 shows a case where the fireproof doorframe having a water curtain includes two covers and water injection parts are provided on the inside and the outside the door as in the embodiment shown in FIG. 5.

That is, the groove 1010 is formed in the facing end of the door supporting part 300 inwards the provisional doorframe 1000, the first end cover part 100 that covers the groove 1010 may be accommodated in the groove 1010, and the second tank accommodating part 130 formed as an internal closing space is formed.

The second through hole 140 is formed so as to penetrate the lower surface of the second water tank accommodating part 130 in a direction facing the door.

The second water tank 800 is accommodated in the second water tank accommodating part 130, and the second nozzle parts 710 formed so as to be inclined toward the door are formed in the lower end, similarly to the first water tank 700.

The second nozzle parts 710 are inserted into the second through hole 140 formed in the door supporting part 300, and in this case, the second nozzle parts 710 are formed in a direction facing the door.

The water is supplied to the second water tank 800 through the water line 600. In case of fire, the first water tank 700 serves to form a water curtain on the outside of the door, and the second water tank 800 serves to form a water curtain on the inside of the door. Accordingly, it is possible to doubly achieve fire resistance and an operation of sealing the poisonous gas by forming the water curtains on the inside and the outside of the door.

### Third Embodiment

FIG. 9 is a diagram showing a third embodiment of the fireproof doorframe having a water curtain of the present invention.

The third embodiment of the present invention corresponds to a case where a fireproof doorframe having a water curtain includes three covers by separately forming the second end cover part 400 in the second cover 30 of the second embodiment.

The fireproof doorframe having a water curtain of the third embodiment includes a first end cover 40 that is fixed so as to cover one end of the provisional doorframe, a central cover 50, and a second end cover 60 that is fixed so as to cover the facing other end of the provisional doorframe.

The first end cover 40 has the same configuration as that of the first cover 20 of the second embodiment.

The central cover 50 includes only the door accommodating part 200 and the door supporting part 300, and does not include the second end cover part 400, unlike the second embodiment.

In the third embodiment, the first groove 210 is formed at the upper end of the door supporting part 200 close to the first end cover 40 in the door accommodating part 200 of the central cover 50 in order to accommodate the upper side cover part 120 of the first end cover 40 extending in the horizontal direction as in the second embodiment.

The second end cover part 60 is formed by separating the second end cover part 400 from the second embodiment, and the upper side cover part 420 is formed so as to extend in the horizontal direction.

A second groove 340 is formed in the upper end of the door supporting part 200 close to the second end cover 60 in the door accommodating part 200 of the central cover 50 in order to accommodate the upper side cover part 420 of the second end cover 60 extending in the horizontal direction.

The other configuration in which the first water tank accommodating part 310 for accommodating the first water tank 700 for accommodating water in the door supporting part 300 is formed and the first through hole 320 into which the first nozzle parts 710 are inserted formed in the water tank accommodating part 310 is the same as that of the first or second embodiment.

As in the first and second embodiments, the groove 330 into which the gasket 500 is inserted is formed on the stepped side of the door supporting part 300 adjacent to the door accommodating part 200.

Similarly to the first and second embodiments, the water line 600 is connected to the end of the first water tank 700, and the valve 610 is provided at the water line 600.

It is possible to exhibit the same effects of preventing the door from being burned and preventing the poisonous gas from being introduced due to water sprinkling as those in the first and second embodiments.

The third embodiment in which the fireproof doorframe having a water curtain includes three covers can be applied to a case where the width of the provisional doorframe is greater than that of the second embodiment in which the fireproof doorframe having a water curtain includes two covers.

In the second and third embodiments of the present invention, it is possible to obtain fire resistance in the corners of the upper end of the door by forming the fireproof doorframe having a water curtain on the side of the door as in the first embodiment.

### Fourth Embodiment

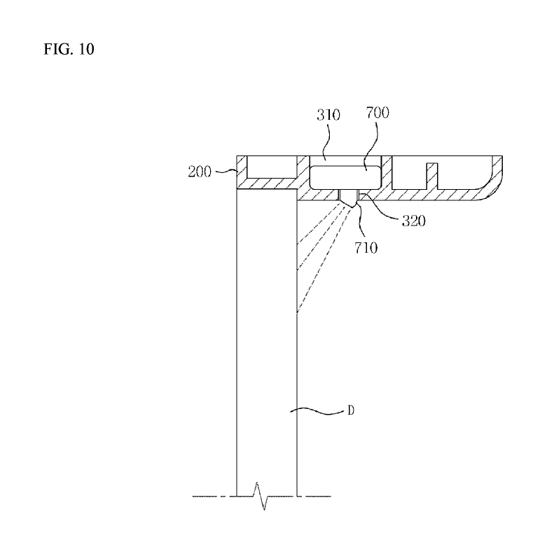

FIG. 10 is a diagram showing a fourth embodiment of the fireproof doorframe having a water curtain of the present invention.

The fourth embodiment of the present invention corresponds to a case where the door is provided at the end of the door, and corresponds to a fireproof doorframe having a water curtain in which a nozzle hole is formed such that water is injected toward the door from the doorframe by using a rear space of the door as a water accommodating part. Thus, the fourth embodiment is different from the first and third embodiments in that the door is provided at the center of the doorframe and is provided at the provisional doorframe.

The fireproof doorframe having a water curtain of the fourth embodiment includes the door accommodating part 200, and the door supporting part 300.

The door accommodating part 200 serves to support and accommodate the side end and the upper end of the door D.

The door supporting part 300 is formed on the side of the door accommodating part 200 so as to be stepped upwards. The water tank accommodating part 310 is formed within the door supporting part 300. The first water tank accommodating part 310 may be formed in a shape of which the end is open.

The first through hole 320 into which the first nozzle parts 710 are inserted are formed in the lower surface of the first water tank accommodating part 310.

The configuration in which the water line 600 on which the valve 610 is provided is connected to the first water tank 700 is the same as that of the first embodiment.

In the fourth embodiment, it is possible to exhibit the same effects of preventing the door from being burned and preventing the poisonous gas from being introduced due to water sprinkling as those in the first embodiment.

In the fourth embodiment, by forming a hollow space in the inside of the provisional doorframe filled with any material, the hollow space can be utilized as the first water tank accommodating part 310 for accommodating the first water tank 710 in order to reduce the weight and the material.

In the second to forth embodiments of the present invention, it is possible to ensure fire resistance in the corners of the upper end of the door by forming the fireproof doorframe having a water curtain on the side of the door as in the first embodiment.

In the second and third embodiments of the present invention, by forming the second water tank accommodating part 130 at the end cover part 100 so as to be inserted into the groove 1010 formed inside the provisional doorframe 1000 in the facing end of the door supporting part 300 in the first end cover part, it is possible to obtain the same operation of forming the water curtains on the inside and the outside of the door.

Although it has been described in the aforementioned embodiments that the fireproof doorframe having a water curtain includes one to three covers, the technical scope of the present invention is not limited thereto.

Although not directly shown in the present specifications, when a plurality of covers which is four or more covers is formed, the fireproof doorframe having a water curtain which has the same effects as those of the present invention should be interpreted as being included in the technical scope of the present invention.

### INDUSTRIAL APPLICABILITY

The present invention relates to a fireproof doorframe for saving human lives such as disabled persons or the old and the infirm by providing a fireproof doorframe having a water curtain in a space where a combustible material is not present during the construction of all buildings such as houses to prevent a flame and a poisonous gas from being introduced into the inside of the building in case of fire.

1. A fireproof doorframe having a water curtain that is provided so as to cover a provisional doorframe, the fireproof doorframe comprising:
a first end cover part that includes a side cover part which covers a side end of the provisional doorframe, and an upper side cover part which covers an upper side of the provisional doorframe;
a door accommodating part that is formed so as to protrude upwards from the upper side cover part;
a door supporting part that is formed so as to be stepped upwards from a side of the door accommodating part;
a second end cover part that includes a side cover part which is formed adjacent to the door supporting part to cover a facing side end of the provisional doorframe, and an upper side cover part which covers a facing side upper side of the provisional doorframe; and
a first water tank that is accommodated in the door accommodating part, and is provided with nozzle parts formed in a direction facing the door,
wherein a first water tank accommodating part that is formed within the door supporting part so as to be opened upwards, and is capable of providing the first water tank, and
a through hole for accommodating the nozzle parts is formed in a lower surface of the first water tank accommodating part.

2. A fireproof doorframe having a water curtain that is provided so as to cover a provisional doorframe, the fireproof doorframe comprising:
a first cover that is fixed so as to cover one end of the provisional doorframe;
a second cover that is fixed so as to cover the facing other end of the provisional doorframe; and
a first water tank that is accommodated in the second cover, and is provided with nozzle parts formed in a direction facing a door,
wherein the first cover includes a first end cover part that includes a side cover part which covers a side of the one end of the provisional doorframe, and an upper side cover part which covers an upper side of the one end of the provisional doorframe,
the second cover includes a door accommodating part formed so as to protrude upwards from the upper side cover part, a door supporting part formed so as to be stepped upwards from a side of the door accommodating part, and a second end cover part which is formed adjacent to the door supporting part, and includes a side cover part which covers a facing side end of the provisional doorframe and an upper side cover part which covers a facing side upper side of the provisional doorframe,
a first water tank accommodating part that is formed so as to be opened upwards and is capable of providing the first water tank is provided within the door supporting part, and
a through hole for accommodating the nozzle parts is formed in a lower surface of the first water tank accommodating part.

3. A fireproof doorframe having a water curtain that is provided so as to cover a provisional doorframe, the fireproof doorframe comprising:
a first end cover that is fixed so as to cover one end of the provisional doorframe;
a central cover that is fixed so as to cover the first cover;
a second end cover that is disposed adjacent to the central cover, and is fixed so as to cover the facing other end of the provisional doorframe; and
a first water tank that is accommodated in the central cover, and is provided with nozzle parts formed in a direction facing a door,
wherein the first end cover includes a first end cover part that includes a side cover part which covers a side of the one end of the provisional doorframe, and an upper side cover part which covers an upper side of the one end of the provisional doorframe,
the central cover includes a door accommodating part formed so as to protrude upwards from the upper side cover part, and a door supporting part formed so as to be stepped upwards from a side of the door accommodating part,
the second end cover includes a side cover part that covers the facing other end of the provisional doorframe, and an upper side cover part that covers an upper side of the one end of the provisional doorframe,
a first water tank accommodating part that is formed so as to be opened upwards and is capable of providing the first water tank is formed within the door supporting part, and
a through hole for accommodating the nozzle parts is formed in a lower surface of the first water tank accommodating part.

4. The fireproof doorframe having a water curtain according to claim 1,
wherein the end cover part, the door accommodating part, and the door supporting part are integrally formed.

5. The fireproof doorframe having a water curtain according to claim 2,
wherein a first groove is formed in an upper end of the door supporting part in order to accommodate the upper side cover part extending in a horizontal direction of the first end cover part.

6. The fireproof doorframe having a water curtain according to claim 3,
wherein a first groove is formed in an upper end of the door supporting part in order to accommodate the upper side cover part extending in a horizontal direction of the first end cover part, and
a second groove is formed in an upper end of the door accommodating part in order to accommodate the upper side cover part extending in a horizontal direction of the second end cover part.

7. The fireproof doorframe having a water curtain according to claim 1,
wherein an insertion groove for accommodating a gasket is formed in a stepped end of the door supporting part adjacent to the door accommodating part.

8. The fireproof doorframe having a water curtain according to claim 1,
wherein a water line for supplying water from the outside is connected to the first water tank.

9. The fireproof doorframe having a water curtain according to claim 8,
wherein a valve that is controlled so as to be manually or automatically opened and closed is provided at the water line.

10. The fireproof doorframe having a water curtain according to claim 1,
wherein a groove is formed in the provisional doorframe in an inward direction of the first end cover part, and
a second water tank accommodating part that is accommodated in the groove and is formed as an internal closing space is formed at the first end cover part.

11. A fireproof doorframe having a water curtain, comprising:
a door accommodating part that is formed at one end so as to accommodate a door; and
a door supporting part that is formed so as to be stepped upwards with respect to the door accommodating part,
wherein a first water tank accommodating part formed as a closing space is formed within the door supporting part, and
a first nozzle hole is formed in a lower surface of the first water tank accommodating part in a direction facing a door.

12. A method of construing the fireproof doorframe having a water curtain according to claim 1,
wherein the fireproof doorframe having a water curtain is constructed on any one end of the upper end and the side end of the door of the fireproof doorframe having a water curtain, or both ends thereof.

13. The method of construing the fireproof doorframe having a water curtain according to claim 12,
wherein the first water tank of the fireproof doorframe having a water curtain which is provided at the upper end and the first water tank of the fireproof doorframe having a water curtain which is provided at the side end are integrally formed.

14. The method of construing the fireproof doorframe having a water curtain according to claim 12,
wherein the fireproof doorframe having a water curtain is constructed such that an extension line of a central line of the nozzle part of the fireproof doorframe having a water curtain which is constructed at a side end of the door crosses an extension line of a central line of the nozzle part of the fireproof doorframe having a water curtain which is constructed at a top of the door.

15. A fireproof doorframe system having a water curtain including the fireproof doorframe having a water curtain according to claim 9,
wherein an air supply device is additionally provided in a space where the fireproof doorframe having a water curtain is provided,
the air supply device includes an air supply fan that introduces external air to supply the introduced air into the space, and an emergency power source that drives the air supply fan, and
the air supply fan is controlled so as to be simultaneously operated when the valve is opened.
